(19) United States
(12) Patent Application Publication
(10) Pub. No.: US 2018/0351870 A1
(43) Pub. Date: Dec. 6, 2018

(54) ON DEMAND DATA VOLUME PROVISIONING

(71) Applicant: Red Hat, Inc., Raleigh, NC (US)

(72) Inventors: Huamin Chen, Westborough, MA (US); Jay Vyas, Concord, MA (US)

(21) Appl. No.: 15/608,264

(22) Filed: May 30, 2017

(51) Int. Cl. H04L 12/851; G06F 3/06

(52) U.S. Cl. CPC H04L 47/24; H04L 67/1097; G06F 3/0635

(57) ABSTRACT

On demand data volume provisioning is disclosed. For example, a first memory accessible to first and second accounts stores a temporary directory. Physically separate second and third memories are across a network from the first memory. The first account requests to create a first file in the temporary directory. A first storage controller creates a first storage layer assigned to the first account in the second memory linked to the temporary directory. The first file is stored on the first storage layer and first metadata associated with the first storage layer is updated. The second account requests to create a second file in the temporary directory. A second storage controller creates a second storage layer assigned to the second account in the third memory linked to the temporary directory. The second file is stored on the second storage layer and second metadata associated with the second storage layer is updated.

### BACKGROUND

The present disclosure generally relates to provisioning storage in a network environment. Typically, there are economies of scale for deploying computer hardware in data centers. For certain tasks requiring specialized hardware such as supercomputers or distributed computer clusters for processing large data sets, individual users of such hardware may use relatively small portions of the total capacity of the hardware. In many cases, such hardware may be hosted in multi-user network environments to achieve utilization rates justifying the deployment of such hardware. Inputs and outputs for such systems may require large amounts of storage space, and may typically be hosted in network storage nodes connected to nodes offering processing capacity. In some examples, the scalability of cloud based infrastructure including virtualization techniques may be used to host the processing and/or data storage requirements for the analysis of large data sets.

### SUMMARY

The present disclosure provides a new and innovative system, methods and apparatus for on demand data volume provisioning. In an example, a first memory is associated with a filesystem, which is accessible to a plurality of accounts each associated with a respective account identifier including first and second accounts associated with first and second account identifiers. A plurality of directories including a temporary directory is stored in the filesystem. A plurality of memories including second and third memories are located across a network from the first memory, and the second memory is physically separate from the third memory. One or more processors are communicatively coupled with the first memory. A metadata server executes on the one or more processors to receive a first request from the first account to create a first file in the temporary directory. A first storage controller associated with the second memory is requested to create a first storage layer in the second memory that is linked to the temporary directory. The first storage layer is assigned to the first account. The first file is stored on the first storage layer on the second memory, where the first storage layer is accessible through the temporary directory and first metadata associated with the first storage layer is updated based on storing the first file. A second request is received from the second account to create a second file in the temporary directory. A second storage controller associated with the third memory is requested to create a second storage layer in the third memory that is linked to the temporary directory. The second storage layer is assigned to the second account. The second file in the temporary directory on the second storage layer on the third memory, where the second storage layer is accessible through the temporary directory and second metadata associated with the second storage layer is updated based on storing the second file.

Additional features and advantages of the disclosed method and apparatus are described in, and will be apparent from, the following Detailed Description and the Figures.

### BRIEF DESCRIPTION OF THE FIGURES

FIG. 1 is a block diagram of a system provisioning on demand data volumes according to an example of the present disclosure.

FIG. 2 is a block diagram comparing physical file storage vs. logical file storage in a system provisioning data volumes on demand according to an example of the present disclosure.

FIG. 3 is a block diagram comparing different perspectives of the same filesystem in a system provisioning data volumes on demand according to an example of the present disclosure.

FIG. 4 is a flowchart illustrating an example of provisioning data volumes on demand according to an example of the present disclosure.

FIG. 5 is flow diagram of an example of provisioning data volumes on demand according to an example of the present disclosure.

FIG. 6 is a block diagram of an example system for provisioning data volumes on demand according to an example of the present disclosure.

### DETAILED DESCRIPTION OF EXAMPLE EMBODIMENTS

Computer systems handling large data sets, sometimes referred to as “big data” operations, often requires specialized software and hardware due to inadequacies of traditional data processing applications in handling such large data sets. These types of data sets are often found in fields such as internet search, finance, business informatics, urban informatics, meteorology, genomics, and simulations in physics, biology and environmental research. Often times these data sets progress in size beyond the capabilities of traditional database infrastructures to produce desired analytical results in a timely fashion. Distributed storage and processing of big data sets across commoditized computer clusters may therefore be utilized in these fields to produce meaningful results from these data sets, for example, using systems such as Apache Hadoop®. In some typical embodiments, virtualization through the use of isolated guests such as virtual machines (“VMs”) and/or containers may be used, especially in conjunction with a multi-tenant cloud based environment where new virtual resources may be deployed in an on demand basis. Virtualization may allow wide spread, parallel deployment of computing power for specific tasks.

A major drawback in distributed processing systems such as Apache Hadoop® is that a metadata server may typically present a significant bottleneck in processing throughput since the metadata server may track where all of the pieces of the large data sets being processed are at any given point in time. In order to maintain data consistency, these metadata operations for file handling may typically be serially processed. In part, serial processing avoids potential race conditions, an illustrative example may be shown where a transient file may be deleted soon after its creation, but in a parallel processing situation, the metadata operation for the deletion may be handled by a first processor while the creation is still queued on a second processor. In such a scenario, the deletion process may error out being unable to locate the appropriate file, or the deletion process may delete a file that is pending an update, which may result in further errors in a corresponding update operation. In either case, unexpected results may occur due to a race condition between parallel processing threads resulting in the possibility of the data stored in memory being different from the data a programmer expects to be in the memory. Similarly, an update for remaining storage capacity on a given storage node may not register until after a new file has been sent to the node for storage based on stale data. However, as the number of users and files grow for a given metadata server to handle, each metadata operation may take longer as the size of the metadata grows in proportion to the files being handled. In a typical mature system, metadata operation contention caused by the serial processing bottleneck may account for up to one third of the total time spent on file handling input/output (“I/O”) operations by the system. In an example, a major generator of file I/O requiring metadata updates is the large amount of temporary files used in intermediary processing steps by systems such as Apache Hadoop®.

The present disclosure aims to address existing challenges in the bottleneck presented by the metadata server in distributed processing systems by provisioning data volumes on demand. In a typical example, a metadata server's workload is driven by at least two factors, growth in the size of the metadata file containing the relevant descriptors of each file in the file system, such as file name, file size, location, and various timestamps, and growth in the number of files in the file system, driven by many users sharing the same infrastructure running many different jobs. A significant driver of the exponential workload of a metadata server as file I/O and file count increases may be due to serial processing of metadata operations within a given namespace to avoid errors caused by competing parallel processes. In many environments, a primary driver of metadata operations involves temporary files created, updated, and deleted in the processing of data sets.

In a shared environment, a multi-layered storage architecture such as Overlay FS may be employed to divide the metadata operations required to handle temporary files in the shared environment. By splitting a given directory into multiple individual name spaces, one large metadata file handled solely by the metadata server may be split into many small metadata files handled by the metadata server in conjunction with a plurality of storage controllers. In an example, each account with access to the distributed processing system may have access to the same temporary directory for storing temporary files. By implementing a multi-layered storage architecture, the actual physical storage in the temporary directory may be split into multiple account specific layers. If each account specific layer is provisioned on a separate physical storage node such as a hard drive, flash memory, solid state drive, random access memory, etc., many of the metadata operations associated with each specific file in relation to location, size, timestamp, etc., may be performed by a storage controller of the physical storage node corresponding to the account specific storage layer on a metadata file associated with the physical storage node. The metadata server may aggregate data from the separate metadata files of the various physical storage nodes and/or storage layers to present a comprehensive metadata driven logical view of the contents of the temporary directory. In such an example, because the logical view may require many fewer updates, a contention inducing number of I/O operations to the central metadata file managed by the metadata server may be avoided. For example, if a storage controller manages the physical storage of a given file, the metadata server may not update the central metadata file when the given file is updated or moved, since the central metadata file may only require an appropriate link to direct requests for the given file to the storage controller. With the removal of the metadata bottleneck caused by the metadata server, the overhead incurred by metadata operations becomes negligible, resulting in an up to 30-40% decrease in latency on file handling operations. Temporary files are especially suited to this application of multi-layered storage for several reasons. First, temporary files are typically account specific, and accessing another account's temporary files may not be commonly required. Second, temporary files often have a high likelihood of naming contention which is avoided in a multi-layered system, because different accounts are in different name spaces so the different accounts may share file names with each other, since each account automatically sees the copy of the file on that account's version of the temporary directory rendering such naming contention moot. As a result, energy usage and heat generation for the system may decrease by enabling more efficient data handling and processing on the same hardware. In addition, cleanup of temporary files for a given account may be streamlined because the files would be aggregated in a single location, streamlining reusability and the sharing of compute resources.

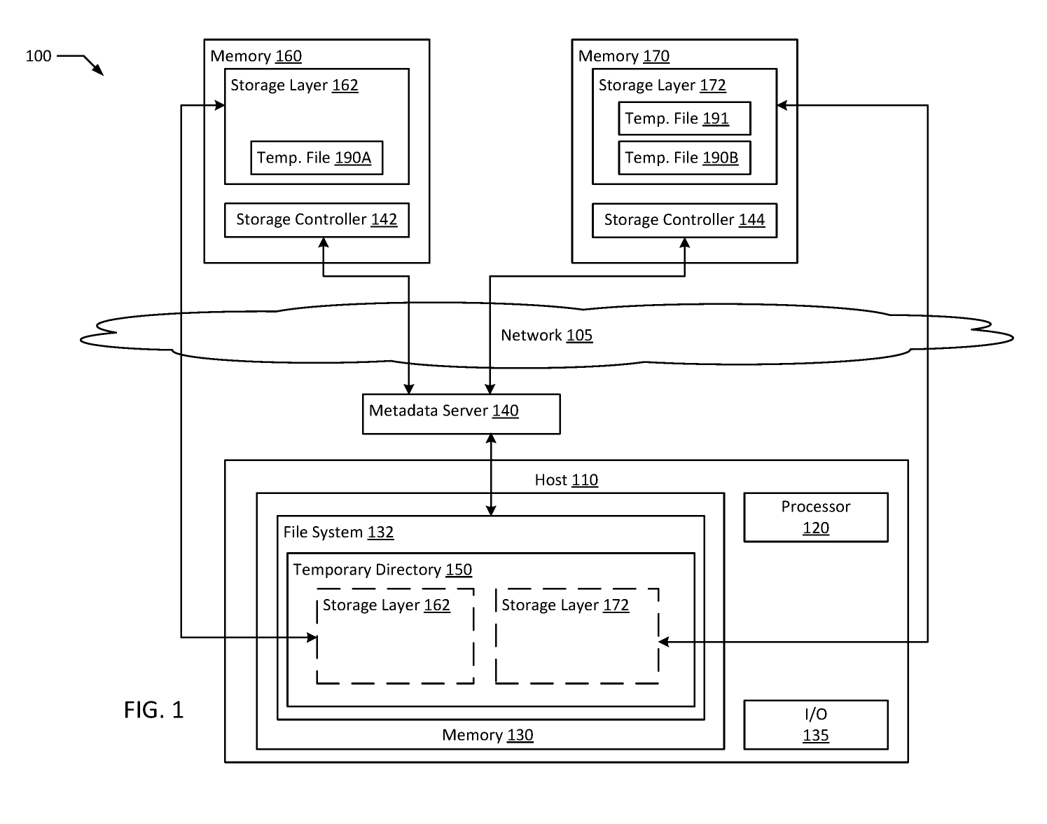

FIG. 1 is a block diagram of a system provisioning on demand data volumes according to an example of the present disclosure. The system 100 may include one or more interconnected hosts (e.g., host 110). Host 110 may in turn include one or more physical processors (e.g., processor 120) communicatively coupled to memory devices (e.g., memory 130) and input/output devices (e.g., I/O 135). As used herein, physical processor 120 refers to a device capable of executing instructions encoding arithmetic, logical, and/or I/O operations. In one illustrative example, a processor may follow Von Neumann architectural model and may include an arithmetic logic unit (ALU), a control unit, and a plurality of registers. In an example, a processor may be a single core processor which is typically capable of executing one instruction at a time (or process a single pipeline of instructions), or a multi-core processor which may simultaneously execute multiple instructions. In another example, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU).

As discussed herein, a memory 130 refers to a volatile or non-volatile memory device, such as RAM, ROM, EEPROM, or any other device capable of storing data. As discussed herein, I/O device 135 refers to a device capable of providing an interface between one or more processor pins and an external device, the operation of which is based on the processor inputting and/or outputting binary data. Processor 120 may be interconnected using a variety of techniques, ranging from a point-to-point processor interconnect, to a system area network, such as an Ethernet-based network. Local connections within host 110, including the connections between a processor 120 and a memory device 130 and between a processor 120 and an I/O device 135 may be provided by one or more local buses of suitable architecture, for example, peripheral component interconnect (PCI).

In an example, host 110 may run one or more isolated guests. In another example, host 110 may be an isolated guest such as a virtual machine or container executing on top of physical hardware. In such an example, processor 120, memory 130, and I/O 135 may be virtualized resources. For example, host 110 may be a VM running on physical hardware executing a software layer (e.g., a hypervisor) above the hardware and below host 110. In an example, the hypervisor may be a component of a host operating system. In another example, the hypervisor may be provided by an application running on the operating system, or may run directly on the physical hardware without an operating system beneath it. The hypervisor may virtualize the physical layer, including processors, memory, and I/O devices, and present this virtualization to host 110 as virtual devices.

Host 110 may run on any type of dependent, independent, compatible, and/or incompatible applications. In an example, metadata server 140 may be an application that handles metadata operations for file system 132 in memory 130. In the example, metadata server 140 may be written in any suitable programing language. In an example, metadata server 140 may be further virtualized and may execute in an isolated guest executing on host 110, for example, in a VM or container. In an example, temporary directory 150 is a directory in file system 132 storing temporary files (e.g., /tmp). In an example, memory 160 and memory 170 may be volatile or non-volatile memory device, such as RAM, ROM, EEPROM, or any other device capable of storing data. In an example, memory 160 and memory 170 may be located across a network 105 from memory 130. Network 105 may be, for example, a public network (e.g., the Internet), a private network (e.g., a local area network (LAN) or wide area network (WAN)), or a combination thereof. In an example, memory 130, memory 160, and memory 170 may be interconnected in any suitable way and may be in any physical configuration with regards to each other. In the example, memories 130, 160, and 170 are in separate physical devices each with a separate storage controller (e.g., storage controllers 142 and 144). In an example, storage layer 162 may be a storage layer managed by storage controller 142, and storage layer 162 may be associated with a first account. In an example, storage layer 162 is physically located on memory 160 and logically accessible through temporary directory 150 on memory 130. In an example, temporary file 190A is stored in storage layer 162. In an example, storage layer 172 may be a storage layer managed by storage controller 144, and storage layer 172 may be associated with a first account. In an example, storage layer 172 is physically located on memory 170 and logically accessible through temporary directory 150 on memory 130. In an example, temporary files 190B and 191 are stored in storage layer 172. In an example, temporary directory 150 may include all three temporary files 190A, 190B, and 191. In an example, temporary files 190A and 190B may share the same file name. In an example, memories 160 and 170 are configured to allow file system layering (e.g., OverlayFS). In the example, rights may be restricted on a per account and per layer basis. In an example, the temporary directory 150 may be stored on a lower system layer that is write-protected from the accounts writing data to the temporary directory 150. The illustrated system 100 depicts storage layer 162 storing temporary file 190A on physical memory 160, storage layer 172 storing temporary files 190B and 191 on physical memory 170, with both storage layer 162 and storage layer 172 logically incorporated into temporary directory 150 on physical memory 130. In the example, the contents of both storage layer 162 and storage layer 172 are accessible to host 110 through temporary directory 150. In an example, a multi-layer system may include multiple upper layers, accessible and/or writeable by different accounts, groups of accounts, and/or permission levels. In the illustrated example 100, read, write, and access rights may be provisioned on a per account and/or account group basis within shared directories such as temporary directory 150 for the various storage layers (e.g., storage layer 162 and 172) stored in the directory (e.g., temporary directory 150).

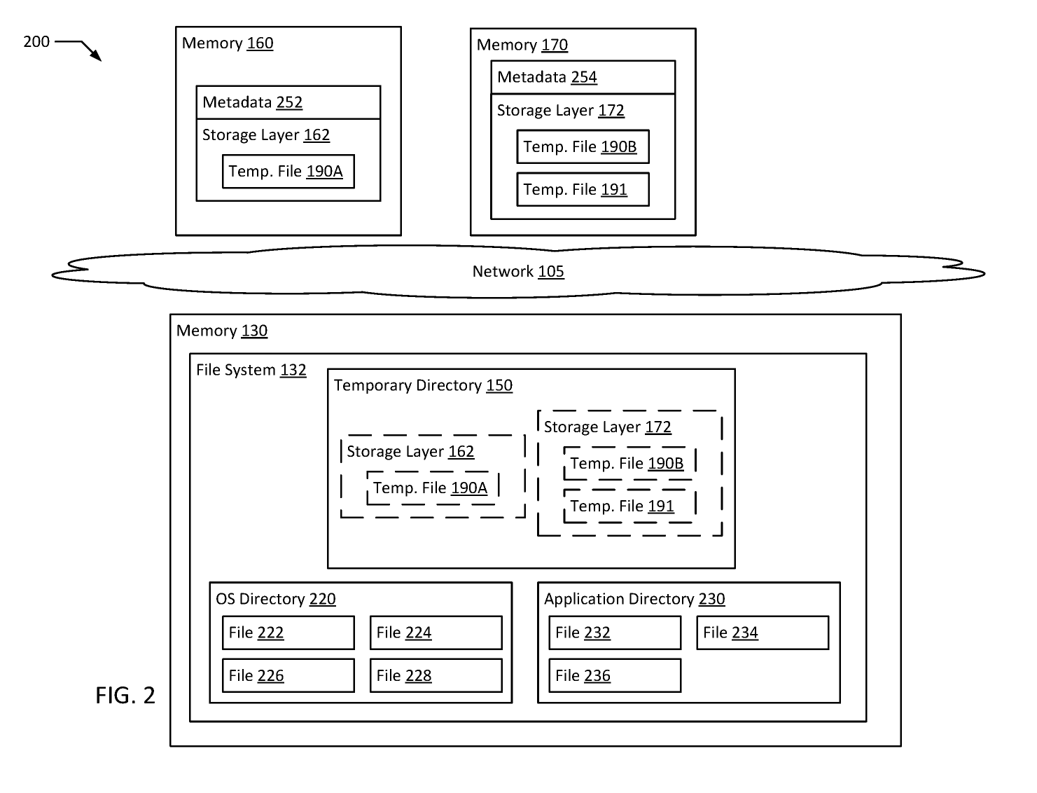

FIG. 2 is a block diagram comparing physical file storage vs. logical file storage in a system provisioning data volumes on demand according to an example of the present disclosure. Illustrated system 200 depicts an example of file system 132's directory structure and the interplay between various logical storage layers included within file system 132. In the example, file system 132 may be primarily hosted on memory 130, but file system 132 may include logical connections (e.g., links, mounts, etc.) of storage volumes physically located on other physical memory devices (e.g., memories 160 and 170). In the example, memory 130 is the primary memory associated with host 110, such as an onboard memory on a physical host 110. In another example, host 110 may be virtualized and memory 130 may be a memory storing host 110's operating system files. In an example, OS directory 220 and application directory 230, along with associated files 222, 224, 226, 228, 232, 234, and 236 are all part of a core build of host 110 and are shared by all accounts using host 110. In an example, especially where host 110 is virtualized, OS directory 220 and application directory 230, along with associated files 222, 224, 226, 228, 232, 234, and 236 may be included in an image file from which host 110 is built. In an example, memories 160 and 170 may be located across a network 105 from host 110 and memory 130. In an example, network 105 may include any form of wired or wireless connection, and memory 160 may be physically located anywhere from inches to half way around the earth from memory 130. In an example, close physical proximity improves the performance of memories 160 and 170 in system 200. In the examples, tradeoffs may be made between performance, convenience, redundancy, and availability in locating memories 160 and 170. For example, locating memory 160 on the same physical host as memory 130 (e.g., host 110) may provide the lowest latency for memory operations. However, there may be physical limitations regarding the number of memory devices that may be connected directly to host 110. Therefore, for scalability purposes, memories 160 and 170 may be preferentially hosted in network storage devices located with minimal network latency to host 110. For example, memories 160 and 170 may be hosted on a storage area network (SAN) or network attached storage (NAS) device in the same data center or even on the same rack as host 110.

In an example, memories 160 and 170 may be any suitable form of memory device with a corresponding storage controller (e.g., storage controllers 142 and 144), where the storage controllers manage metadata (e.g., metadata 252 and 254) independently of metadata server 140. For example, metadata server 140 may include file structure and file storage information for memory 130, host 110, and/or a plurality of hosts and memories with similar file handling responsibilities to host 110. In an example, storage controller 142 may manage metadata 252 which may be stored in any suitable format (e.g., a file, registry, directory, database, etc.), where metadata 252 includes metadata information relating to files stored in storage layer 162 on memory 160. In an example, metadata 252 may include information on all files stored on memory 160. In another example, metadata 252 may include information on a subset of files stored on memory 160 (e.g., storage layer 162). In an example, metadata 252 includes metadata information relating to temporary file 190A. Similarly, metadata 254 may be managed by storage controller 144 and include information on files in memory 170, including storage layer 172, and temporary files 190B and 191. In an example, memories 160 and 170 may be any form of physical memory device, such as a hard disk drive, solid state drive, flash memory, RAM, logical storage number (LUN) on a SAN device etc. In the example, storage controller 142 may manage metadata 252 separately from and in parallel to storage controller 144 managing metadata 254, or metadata server 140 managing metadata files relating to host 110 including memory 130 and file system 132. In an example, metadata server 140 may read the contents of metadata 252 and metadata 254 without impeding modifications to metadata 252 by storage controller 142 and modifications to metadata 254 by storage controller 144. In an example, storage layers 162 and 172, and temporary files 190A, 190B, and 191 may be logically represented in temporary directory 150 of file system 132 based on logical linkages between temporary directory 150 and memories 160 and 170. In an example, metadata server 140 may update logical representations of the contents of temporary directory 150 (e.g., temporary files 190A, 190B and 191) through reading metadata 252 and 254.

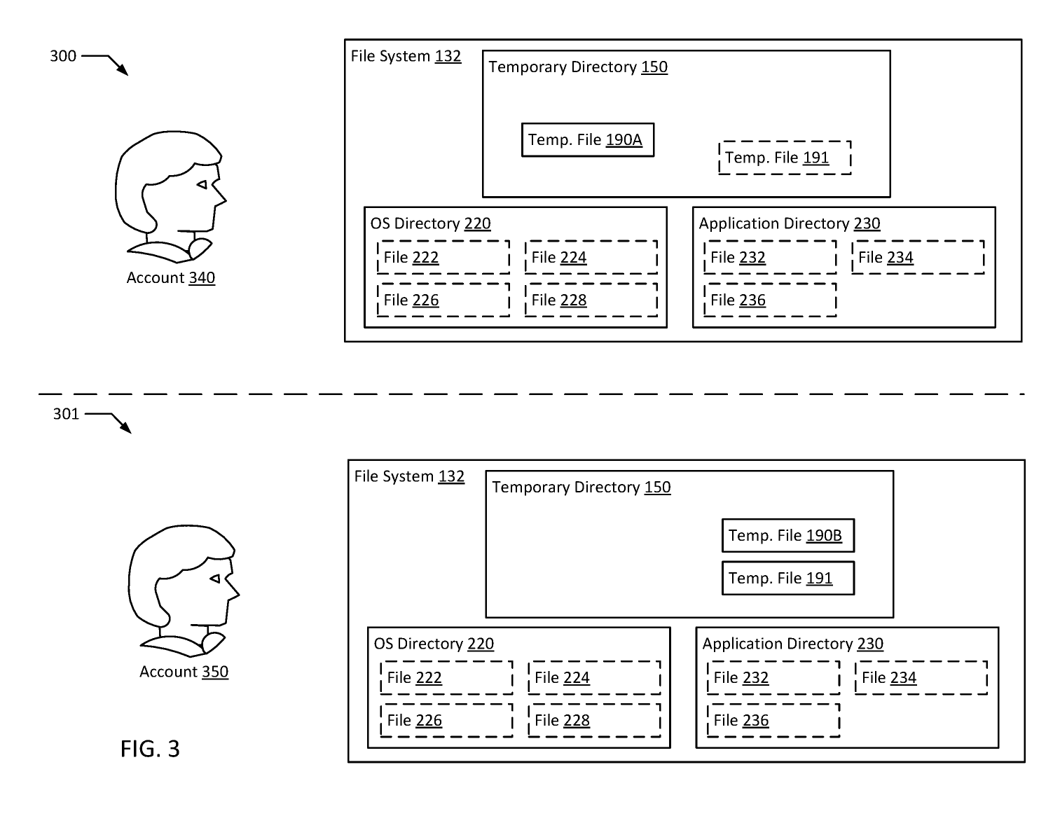

FIG. 3 is a block diagram comparing different perspectives of the same filesystem in a system provisioning data volumes on demand according to an example of the present disclosure. Illustrated systems 300 and 301 depict file system 132 from illustrated system 200 as viewed by two different accounts 340 and 350. In an example, account 340 may be an account associated with storage layer 162. In the example, when account 340 requests a listing of files in file system 132, a list including files 222, 224, 226, 228, 232, 234, 236, and temporary files 190A and 191 may be returned by host 110. In an example account 340 may be a regular user account without elevated rights, and files 222, 224, 226, 228, 232, 234, and 236 may all be permissioned to read-only or read/execute without write permissions for account 340. In an example, permissioning may be set on a per directory basis (e.g., OS directory 220 and application directory 230) for account 340. In an example, OS directory 220 and application directory 230 may be stored to a write-protected lower storage layer of file system 132, where only administrator accounts such as root have access to write to the lower storage layer. In an example, account 340 may be configured to use temporary directory 150 for temporary file I/O. In the example, account 340 may have requested temporary file 190A to be saved, and metadata server 140 may have instructed storage controller 142 to create storage layer 162 on memory 160 to be used by account 340 as an upper storage layer to file system 132. In the example, while account 340 may interface directly with host 110, requesting temporary directory 150 to store temporary file 190A, the actual storage function, including metadata updates relating to the storing of temporary file 190A may be performed remotely on memory 160. In the example, when account 340 requests a listing of files in temporary directory 150, two files may be returned, namely temporary files 190A and 191. In the example, temporary file 191 may belong to another account (e.g., account 350), but account 340 may be permissioned to read and/or execute temporary file 191. In the example, should account 340 request to make changes to temporary file 191, a copy-on-write operation may be performed where a copy of temporary file 191 may be saved with account 340's changes in storage layer 162 after modifications are made. In the example, where two or more conflicting versions of a file are stored in the same logical directory on different storage layers (e.g., storage layers 162 and 172), a copy belonging to the account accessing the directory (e.g., temporary directory 150 being accessed by account 340) may be preferentially returned as compared to a different copy belonging to a different account.

Illustrated system 301 may be an alternative view of the same file system 132 from the perspective of account 350, which is a different non-administrator account from account 340. In an example, account 350 may be associated with storage layer 172 managed by storage controller 144, and stored on memory 170. Account 350 may, similarly to account 340, view OS directory 220 and application directory 230 in file system 132 on memory 130 as write-protected, including the contents of OS directory 220 and application directory 230 (e.g., files 222, 224, 226, 228, 232, 234, and 236). In an example, when account 350 requests to store temporary file 190B and/or temporary file 191 to temporary directory 150, metadata server 140 and/or host 110 may instruct storage controller 144 to create a new storage layer 172 on memory 170 to store temporary files belonging to account 350, including metadata 254 associated with storage layer 172. In an example, temporary file 190A and temporary file 190B are two copies of files with the same name. For example, temporary file 190B may be based on temporary file 190A with minor modifications. In the example, account 350 may have first accessed temporary file 190A in a read-only mode, and requested to save modifications to the file resulting in temporary file 190B. In another example, temporary files 190A and 190B may be copies of a commonly used file in the processing tasks performed by host 110, for example, a configuration file (e.g., file 232) where each processing job performed by an application associated to application directory 230 saves a temporary copy for each specific job. In an example, when account 350 lists the files in temporary directory 150, temporary file 190A is excluded due to the presence of temporary file 190B associated with account 350. In the example, temporary file 191 may be writeable for account 350 due to ownership by account 350, while account 340 may see temporary file 191 as write-protected. In an example, metadata 254 may be updated by storage controller 144 for file updates in temporary directory 150 by account 350 without contention from storage controller 142 or metadata server 140.

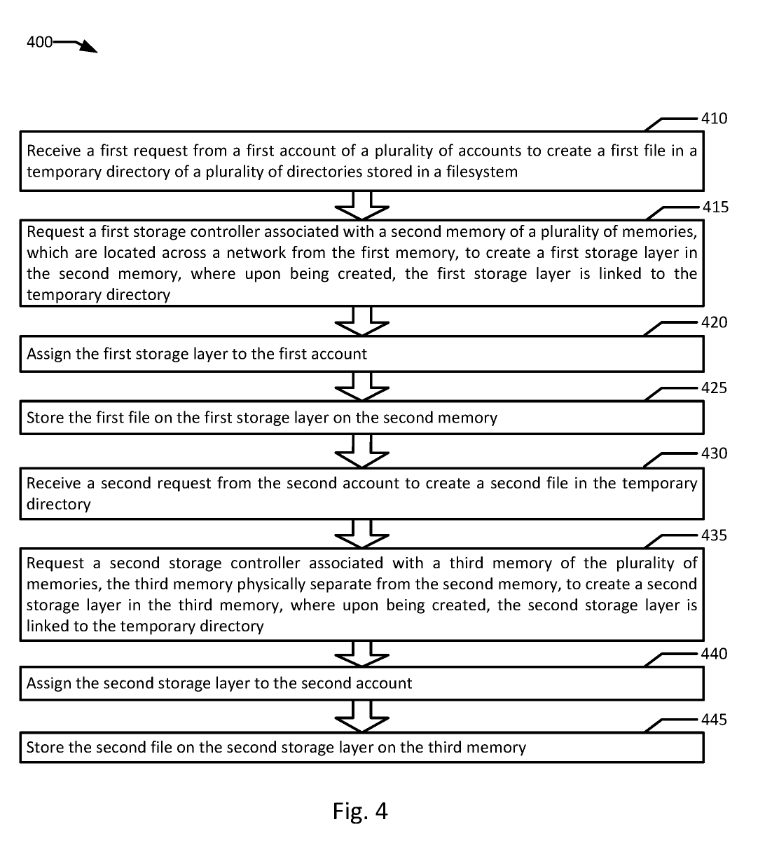

FIG. 4 is a flowchart illustrating an example of provisioning data volumes on demand according to an example of the present disclosure. Although the example method 400 is described with reference to the flowchart illustrated in FIG. 4, it will be appreciated that many other methods of performing the acts associated with the method 400 may be used. For example, the order of some of the blocks may be changed, certain blocks may be combined with other blocks, and some of the blocks described are optional. The method 400 may be performed by processing logic that may comprise hardware (circuitry, dedicated logic, etc.), software, or a combination of both. In an example, the method 400 is performed by a metadata server 140 in conjunction with storage controllers 142 and 144.

Example method 400 may begin with receiving a first request from a first account of a plurality of accounts to create a first file in a temporary directory of a plurality of directories stored in a filesystem, where the filesystem is associated with a first memory and is accessible to the plurality of accounts each, of which are associated with a respective account identifier including the first account, which is associated with a first account identifier, and a second account associated with a second account identifier (block 410). For example, account 340 may request to create temporary file 190A in temporary directory 150 on file system 132, where file system 132 hosts temporary directory 150, OS directory 220, and application directory 230. In the example, file system 132 may be associated with memory 130, and accounts 340 and 350 may access file system 132. In the example, accounts 340 and 350 may each be associated with a respective account identifier, for example, a user identifier (UID). In an example where account 340's UID is already associated with an upper storage layer, the requested temporary file may be directly stored to that associated upper storage layer (e.g., storing temporary file 190A to storage layer 162 on memory 160).

In example method 400, a request may be made to a first storage controller associated with a second memory of a plurality of memories, which are located across a network from the first memory, to create a first storage layer in the second memory, where upon being created, the first storage layer is linked to the temporary directory (block 415). For example, where account 340 has not been previously associated with a storage layer associated with temporary directory 150, a request may be made (e.g., by metadata server 140) to storage controller 142 associated with memory 160 to create storage layer 162, which upon creation, is linked to temporary directory 150. In the example, metadata 252 may be created to save file handling information relating to storage layer 162. For example, file size, location, rights, and time stamps for files in storage layer 162 may be saved in metadata 252. In an example, the first storage layer is assigned to the first account (block 420). For example, storage layer 162 may be associated with account 340. In an example, storage layer 162 is associated with an account identifier (e.g., UID) associated with account 340 and/or a group identifier (e.g., GID) associated with account 340. In an example, associating storage layer 162 with account 340 may include metadata updates, for example, in metadata 252 and/or metadata associated with memory 130, file system 132, and/or temporary directory 150. In an example, metadata server 140 may be configured to redirect access to temporary directory 150 by account 340 from memory 130 to memory 160.

The first file is stored on the first storage layer on the second memory, where the first storage layer is accessible through the temporary directory and first metadata associated with the first storage layer is updated based on storing the first file (block 425). In an example, temporary file 190A is stored on storage layer 162 on memory 160, storage layer 162 being accessible through temporary directory 150. In the example, metadata 252 is updated reflecting the saving of temporary file 190A. In an example, by relocating temporary file 190A to memory 160 from memory 130, metadata updates relating to the storage of temporary file 190A are relocated to metadata 252 on memory 160 instead of being on memory 130. For example, in a typical system where temporary directory 150 is stored in a flat (rather than multi-layered) file system, metadata server 140 would update metadata associated with physical memory 130 relating to the physical location within memory 130 where temporary file 190A is stored. Metadata server 140 may also be required to rename temporary file 190A to avoid contention with copies of temporary files sharing the same name with temporary file 190A (e.g., temporary file 190B). As the number of files in memory 130 increases, file handling operations may slow down at an exponential rate. For example, seeking for space for a new file takes longer as capacity shrinks due, because less contiguous space of sufficient capacity may be available on the storage device. In the example, updates to storage metadata for each file system operation also slows down, in part, due to the metadata increasing in size thereby requiring the handling of a larger file. By shifting the physical storage requirements to storage controller 142 and memory 160, metadata server 140 no longer requires updating for each read/write, and no longer requires actual knowledge of where a given file is stored physically. For example, metadata server 140 may instead periodically update metadata for temporary directory 150 based on a timeout and/or based on requests, and smaller, less frequent metadata updates may be required due to eliminating the need for many contention resolving processing steps.

In a flat file system, metadata server 140 may be required to enforce both uniqueness of file name and uniqueness of file location (e.g., to prevent parts of a file from being physically overwritten), and both of these verifications may be performed instead by storage controller 142 in a multi-layer file system. For example, metadata server 140 may direct an application to store, retrieve, and modify temporary file 190A on storage layer 162, but the physical address of temporary file 190A on memory 160 may be controlled by storage controller 142. Similarly, file names would only require uniqueness within each storage layer since a multi-layer file system may be configured to properly deliver a copy of a similarly named file from the correct storage layer (e.g., temporary file 190A to account 340 and temporary file 190B to account 350). In an example where dozens, even hundreds of accounts share a metadata server and temporary directory, contention often arises on metadata updates in flat file systems. For example, if each account saves one file every second to temporary directory 150, with 100 accounts, 100 reads and writes of a metadata file associated with memory 130 may be required in a flat file system. However, with a multi-layered file system, each metadata read/write may be performed on a separate storage layer on a separate physical memory (e.g., memories 160 and 170 with metadata 252 and 254), with only one read/write of the metadata for memory 130 as a batch update once per second. Therefore, no one storage controller or metadata server becomes the bottleneck for file handling operations for temporary directory 150.

A second request is received from the second account to create a second file in the temporary directory (block 430). In an example, account 350 requests temporary file 190B to be stored in temporary directory 150. Example method 400 may continue with a request to a second storage controller associated with a third memory of the plurality of memories, the third memory physically separate from the second memory, to create a second storage layer in the third memory, where upon being created, the second storage layer is linked to the temporary directory (block 435). In the example, storage controller 144 associated with memory 170 is requested to create storage layer 172 in memory 170 which is linked to temporary directory 150 after creation. In an example, memory 170 may be a physically separate storage device from memory 160 to fully promote the advantages of the present disclosure. For example, writing to one physical memory may generally be conducted serially, including updates to metadata associated with the physical device, in part to avoid overwriting data inappropriately. In the example, if memory 160 and memory 170 shared the same physical memory device, at least some contention would still exist if both storage layer 162 and storage layer 172 were simultaneously accessed. In an example, virtualization may limit the contention and provide a viable option. However, if sufficient file I/O were to occur, a storage controller for the physical memory underlying the shared virtual storages would still present a potential bottleneck. A balance may be found between the number of physical memories utilized for creating storage layers for temporary directory 150 and required performance characteristics. In an example, an optimal number of physical memory devices may be based on having sufficient physical memory devices to avoid metadata operation contention caused by file handling. For example, a system with 100 accounts may require 100 physical memories if each account were to make 100 file handling requests per second, while the same 100 accounts may only require 10 physical memories (with 10 storage layers on each physical memory) if each account only made 10 file handling requests per second. In an example, the relationship between the number of file handling requests made to each physical memory may be non-linear with regards to metadata contention, with exponential contention rates as requests increase. In an example, an appropriate quantity of physical memories may be found for a given system such that metadata contention increases negligibly, where the quantity may be significantly less than one storage per account.

The second storage layer is assigned to the second account (block 440). In an example, storage layer 172 is assigned to account 350 upon creation. In the example, storage layer 172 may be configured in any suitable manner such that storage layer 172 is utilized by default when account 350 requests a file handling operation in temporary directory 150. The second file is stored on the second storage layer on the third memory, where the second storage layer is accessible through the temporary directory and second metadata associated with the second storage layer is updated based on storing the second file (block 445). In an example, at account 350's request, temporary file 190B is stored in storage layer 172 on memory 170 accessible through temporary directory 150. In an example, metadata 254 associated with storage layer 172 is updated based on storing temporary file 190B.

In an example, temporary file 190A and temporary file 190B share a file name, and the metadata server 140 provides temporary file 190A from memory 160 to account 340, and provides temporary file 190B from memory 170 to account 350 based on an account identifier of account 340 and an account identifier of account 350. In another example, another component related to file system 132 may interpret the respective account identifiers of accounts 340 and 350 to provide the accounts with the properly associated versions of the temporary file. In an example, requests from account 340 for files in temporary directory 150 may be routed to storage controller 142, while requests from account 350 may be routed to storage controller 144. In an example, an account (e.g., account 340 and/or account 350) may access a file belonging to another account on a separate memory device using a special command. For example, account 340 may be permissioned to explicitly request temporary file 190B. In such an example, account 340 may be an administrator account with elevated rights. In an example, account 340 may be permissioned to access a file in temporary directory 150 belonging to another account where account 340 does not have a file with the same name. For example, account 340 may be permissioned to read temporary file 191 belonging to account 350 and/or see temporary file 191 in a listing of files in temporary directory 150, where account 340 does not have an associated file with the same name as temporary file 191. In an example, if account 340 issues a command to save temporary file 191, a new copy of temporary file 191 may be created in storage layer 162 with the changes made by account 340. In the example, when account 340 next requests temporary file 191, the copy in storage layer 162 may be retrieved instead of the copy in storage layer 172. In an example as illustrated in system 300, account 340 lists the temporary directory 150 (e.g., executing an ls, dir, etc. command) resulting in a first listing (e.g., temporary files 190A and 191) that excludes temporary file 190B. In the example, from the perspective of account 350 in illustrated system 301, account 350 lists the temporary directory 150, a second listing (temporary files 190B and 191) results excluding temporary file 190A.

In an example, account specific storage layers may enable faster, more efficient clean up of temporary directories. For example, a cleanup routine may include deleting all files in storage layer 162, and/or reclaiming storage layer 162. In an example, a flat, single layer file system may require analysis of each file in temporary directory 150 to determine whether the file belongs to account 340. In an example, with a multi-layer file system, metadata server 140 may determine that the files in storage layer 162 all belong to account 340 and may issue instructions in bulk. For example, a cleanup routine may be triggered by the metadata server 140 restarting and/or the account 340 logging off. In such a scenario, it may be safely determined that temporary files belonging to account 340 may be discarded, potentially after a timeout. To perform a cleanup, all of the files in storage layer 162 may be safely discarded. Alternatively, a less secure but more efficient solution to reuse memory 160 may be to reclaim the portion of memory 160 associated with storage layer 162. For example, rather than deleting and/or overwriting the data in storage layer 162, storage controller 142 may instead drop all metadata references to the data in storage layer 162, for example, by erasing metadata 252. In the example, while the data previously in storage layer 162 may be physically recoverable, a new storage layer replacing storage layer 162 may ignore the contents in the storage and overwrite at will based on the blank location information in updated metadata 252.

In an example, metadata 252 may be associated with an account identifier of account 340, and metadata 254 may be associated with an account identifier of account 350. For example, metadata 252 may be updated to indicate the relationship between storage layer 162 and account 340. In another example, separate metadata files may be maintained on memory 160 for each storage layer/account combination to facilitate quick resets of storage layers. In an example where metadata 252 is uniquely associated with account 340 and storage layer 162, storage layer 162 may be reset upon logout by account 340 by resetting metadata 252.

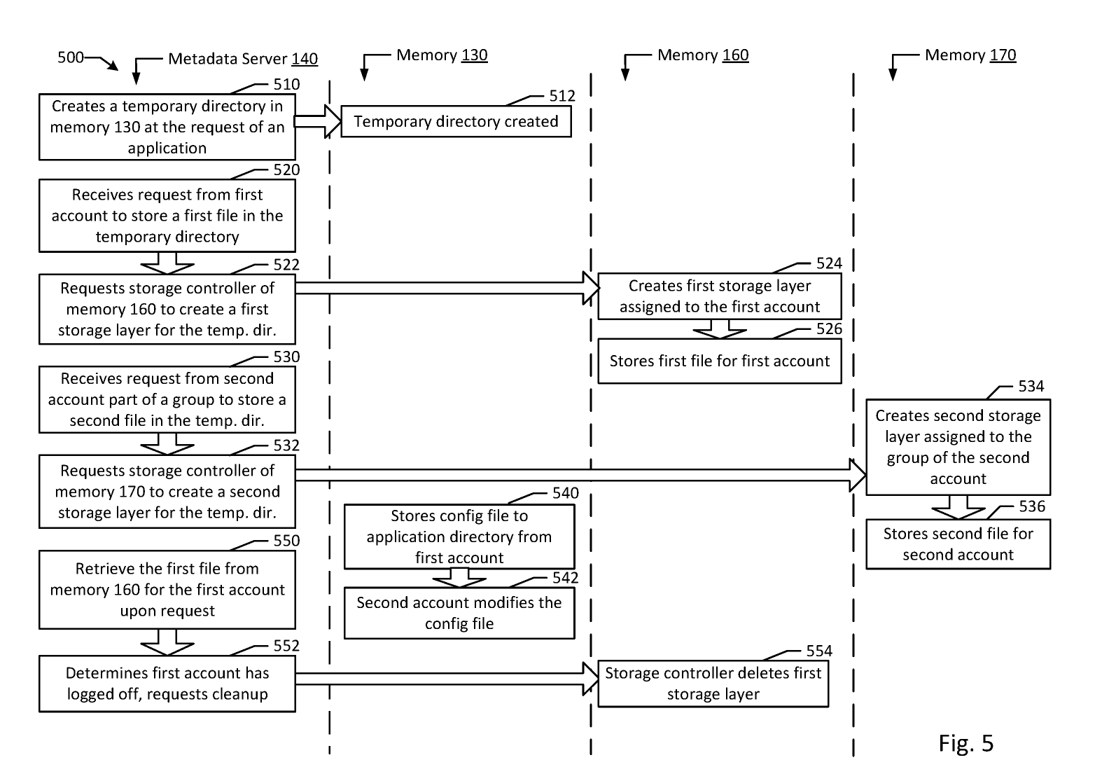

FIG. 5 is flow diagram of an example of provisioning data volumes on demand according to an example of the present disclosure. Although the examples below are described with reference to the flowchart illustrated in FIG. 5, it will be appreciated that many other methods of performing the acts associated with FIG. 5 may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both. In illustrated example 500, a metadata server 140 operates in conjunction with memories 130, 160, and 170 to provision data volumes on demand.

In an example, metadata server 140 creates a temporary directory 150 in memory 130 at the request of an application (e.g., Apache Hadoop®) (block 510). In the example, memory 130 creates temporary directory 150 (block 512). Later, metadata server 140 receives a request from account 340 to store temporary file 190A in temporary directory 150 (block 520). Metadata server 140 may then detect that account 340 does not have an active storage layer on another memory (e.g., memories 160 or 170) for an account specific layered version of temporary directory 150. In the example, metadata server 140 requests storage controller 142 of memory 160 to create storage layer 162 for temporary directory 150 (block 522). Memory 160, for example under the direction of storage controller 142, creates storage layer 162 assigned to account 340 (block 524). Memory 160 then stores temporary file 190A for account 340 in storage layer 162 on memory 160 (block 526).

In an example, metadata server 140 receives a request from account 340 part of a first group of accounts to store file 190B in temporary directory 150 (block 530). In an example, individual accounts (accounts 340 and 350) may belong to larger groups of accounts. For example, account 350 may have an account identifier (e.g., a UID) and also a plurality of group identifiers (e.g., GIDs) signifying groups that account 350 belongs to. In an example, a third account (other than accounts 340 and 350) may belong to a shared group with account 350 with a shared group identifier. In an example, access to a specific storage layer (e.g., storage layer 172) of temporary directory 150 may be based on GID instead of or in addition to being based on UID. In an example, the third account may access storage layer 172 including temporary files 190B and 191 based on a shared GID with account 350. In an example, any suitable combination of permissions and storage layers may be suitable. For example, the third account may be configured to read and access temporary files 190B and 191, but any modifications may be saved to a third storage layer associated with the third account. In another example, to limit the number of physical memories used for storage layers, accounts with a shared group may be configured to use a shared storage layer (e.g., storage layer 172 for account 350 and the third account). A shared group may also be configured to share the same physical memory device (e.g., memory 170) but may be configured to store and access different storage layers on the same memory device. In such an example, as a group increases in size and file handling I/O, metadata operation contention from a storage controller on the memory device (e.g., storage controller 144 on memory 170) may become a bottleneck on throughput for accounts belonging to the group. In an example, metadata server 140 directs the third account to store a third file in temporary directory 150 on storage layer 172 shared with account 350 based on the shared group identifier. In an example, the third account accesses file 190B. In an example, metadata server 140 may determine that neither account 340 nor the first group of accounts (e.g., based on UID and GID) has an assigned storage layer associated with temporary directory 150.

In an example, metadata server 140 requests storage controller 144 of memory 170 to create storage layer 172 for temporary directory 150 (block 532). In an example, memory 170 then creates storage layer 172 assigned to account 350 under the direction of storage controller 144 (block 534). Memory 170 then stores temporary file 190B for account 350 in storage layer 172 on memory 170 (block 536). Meanwhile, account 340 may request memory 130 to store a configuration file 232 to application directory 230 in memory 130. In an example, application directory 230 may be configured with a flat, single layer file system. In the example, memory 130 stores configuration file 232 received from account 340 to application directory 230 (block 540). In an example, account 350 later accesses configuration file 232 and stores an update to configuration file 232 overwriting the version stored by account 340 on memory 130 (block 542). In another example, application directory 230 may also be configured as a multi-layer file system, with account specific layers stored either on memory 130 or on each account's account specific storage layer. For example, configuration file 232 may be inherited as part of a write-protected lower system layer saved to memory 130. In the example, account 340 may create a custom version of configuration file 232 saved to a custom upper storage layer of application directory 230 on memory 130 assigned to account 340. In such an example, when account 340 next accesses configuration file 232, the version in the upper storage layer may be retrieved rather than the write protected lower storage layer version. Similarly, rather than being saved to an upper storage layer on memory 130, account 340's version of configuration file 232 may be saved to memory 160. In such an example, a second directory associated with application directory 230 may be created in storage layer 162 to store configuration file 232. In another example, a separate storage layer may be created in memory 160 to store configuration file 232.

In an example, metadata server 140 may be requested by account 340 to retrieve temporary file 190A from memory 160 (block 550). In an example, account 340 may request temporary file 190A, and metadata server 140 may determine based on an account ID of account 340 that account 340's version of temporary file 190A is located on storage layer 162. In the example, metadata server 140 may forward the request to retrieve temporary file 190A to storage controller 142 on memory 160, and storage controller 142 may handle providing temporary file 190A to account 340.

In an example, after retrieving temporary file 190A and performing operations on the contents of temporary file 190A, account 340 logs off In the example, metadata server 140 may determine that account 340 has logged off and request a cleanup of temporary files and storage used by account 340 (block 552). For example, a login server and/or utility may notify metadata server of the logging off of account 340. In the example, storage controller 142 on memory 160 may delete storage layer 162 to clean up storage used by account 340 (block 554).

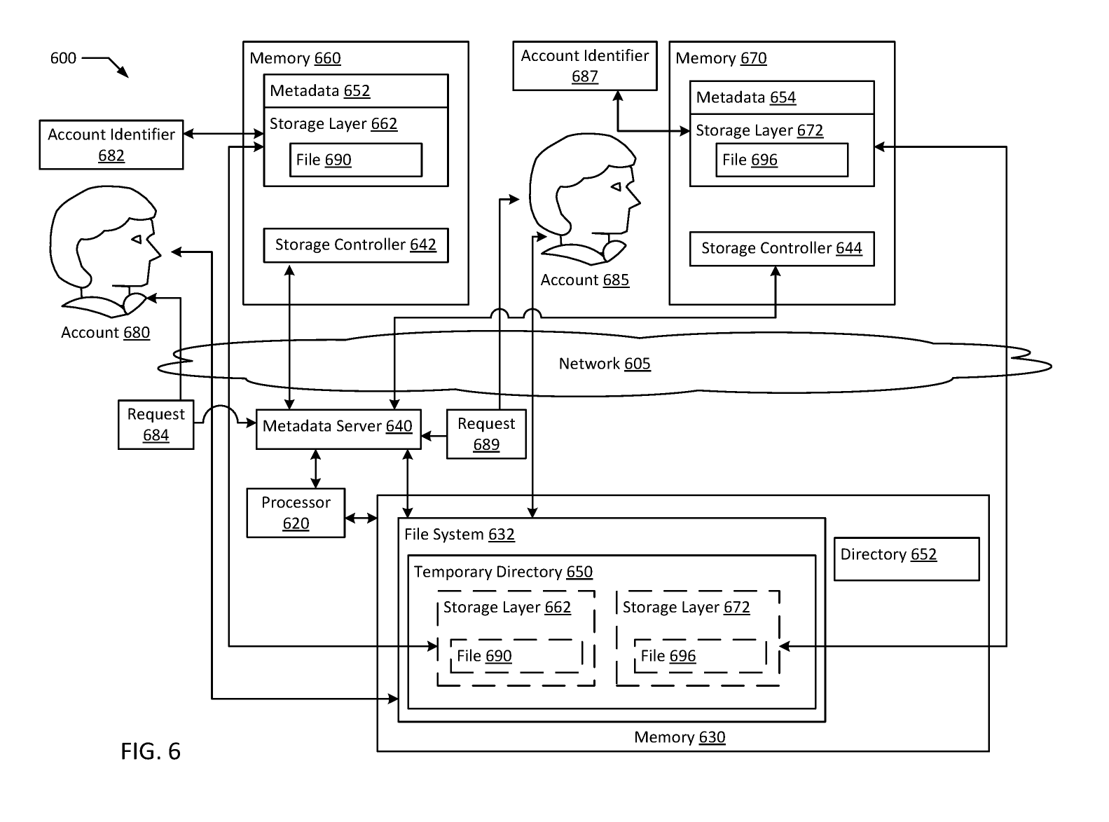

FIG. 6 is a block diagram of an example system for provisioning data volumes on demand according to an example of the present disclosure. Example system 600 includes a memory 630 associated with filesystem 632, where the filesystem 632 is accessible to a plurality of accounts (e.g., accounts 680 and 685) each associated with a respective account identifier (e.g., account identifiers 682 and 687). For example, account 680 is associated with account identifier 682 and account 685 is associated with account identifier 687. System 600 also includes directory 652 and temporary directory 650, which are stored in filesystem 632. System 600 includes memories 660 and 670, which are located across a network 605 from memory 630and memory 660 is physically separate from memory 670. Processor 620 is communicatively coupled with memory 630, and a metadata server 640 executes on processor 620. The metadata server 640 receives a request 684 from account 680 to create file 690 in temporary directory 650. Storage controller 642 associated with memory 660 is requested to create storage layer 662, and upon being created, storage layer 662 is linked to temporary directory 650. Storage layer 662 is assigned to account 680. File 690 is stored on storage layer 662 on memory 660, where storage layer 662 is accessible through temporary directory 650 and metadata 652 associated with storage layer 662 is updated based on storing file 690. A request 689 is received from account 685 to create file 696 in temporary directory 650. Storage controller 644 associated with memory 670 is requested to create storage layer 672, and upon being created, storage layer 672 is linked to temporary directory 650. Storage layer 672 is assigned to account 685. File 696 is stored in the temporary directory 650 on storage layer 672 on memory 670, where storage layer 672 is accessible through temporary directory 650 and metadata 654 associated with storage layer 672 is updated based on storing file 696.

In an example, by shifting the physical storage of files to separate physical devices with isolated namespaces, metadata update contention resulting in file handling I/O latency may be greatly reduced or even eliminated. With a multi-layer file system such as OverlayFS, additional namespaces may be generated on demand, scaling appropriately with shared usage of compute resources. As a result, processing cycles that may be wasted waiting on metadata operations to complete may be reduced resulting in higher throughput of file handling on the same hardware, also resulting in ancillary benefits such as reduced heat generation and power consumption, thereby increasing compute density within data centers.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system of allocating storage, the system comprising:
a first memory associated with a filesystem, wherein the filesystem is accessible to a plurality of accounts each associated with a respective account identifier including a first account associated with a first account identifier and a second account associated with a second account identifier, and a plurality of directories including a temporary directory are stored in the filesystem;
a plurality of memories including at least a second memory and a third memory, wherein the plurality of memories is located across a network from the first memory, and the second memory is physically separate from the third memory;
one or more processors communicatively coupled with the first memory; and
a metadata server executing on the one or more processors to:
receive a first request from the first account to create a first file in the temporary directory;
request a first storage controller associated with the second memory to create a first storage layer in the second memory, wherein upon being created, the first storage layer is linked to the temporary directory;
assign the first storage layer to the first account;
store the first file on the first storage layer on the second memory, wherein the first storage layer is accessible through the temporary directory and first metadata associated with the first storage layer is updated based on storing the first file;
receive a second request from the second account to create a second file in the temporary directory;
request a second storage controller associated with the third memory to create a second storage layer in the third memory, wherein upon being created, the second storage layer is linked to the temporary directory;
assign the second storage layer to the second account; and
store the second file in the temporary directory on the second storage layer on the third memory, wherein the second storage layer is accessible through the temporary directory and second metadata associated with the second storage layer is updated based on storing the second file.

2. The system of claim 1, wherein the first file and the second file share a file name, and the metadata server provides the first file from the second memory to the first account and the second file from the third memory to the second account based on the respective first account identifier and the second account identifier upon request.

3. The system of claim 2, wherein the first account lists the temporary directory resulting in a first listing that excludes the second file and the second account lists the temporary directory resulting a second listing that excludes the first file.

4. The system of claim 1, wherein the second account and a third account belong to a group of accounts, which is associated with a group identifier.

5. The system of claim 4, wherein the metadata server directs the third account to store a third file in the temporary directory on the second storage layer shared with the second account based on the group identifier.

6. The system of claim 4, wherein the third account accesses the second file.

7. The system of claim 1, wherein a cleanup routine includes at least one of deleting all files in the first storage layer, and reclaiming the first storage layer.

8. The system of claim 7, wherein the cleanup routine is triggered by at least one of the metadata server restarting and the first account logging off.

9. The system of claim 1, wherein the first account identifier is associated with the first metadata and the second account identifier is associated with the second metadata.

10. A method of allocating storage, the method comprising:
receiving a first request from a first account of a plurality of accounts to create a first file in a temporary directory of a plurality of directories stored in a filesystem, wherein the filesystem is associated with a first memory and is accessible to the plurality of accounts, each of which are associated with a respective account identifier including the first account, which is associated with a first account identifier, and a second account associated with a second account identifier;
requesting a first storage controller associated with a second memory of a plurality of memories, which are located across a network from the first memory, to create a first storage layer in the second memory, wherein upon being created, the first storage layer is linked to the temporary directory;
assigning the first storage layer to the first account;
storing the first file on the first storage layer on the second memory, wherein the first storage layer is accessible through the temporary directory and first metadata associated with the first storage layer is updated based on storing the first file;
receiving a second request from the second account to create a second file in the temporary directory;
requesting a second storage controller associated with a third memory of the plurality of memories, the third memory physically separate from the second memory, to create a second storage layer in the third memory, wherein upon being created, the second storage layer is linked to the temporary directory;
assigning the second storage layer to the second account; and
storing the second file, including a second metadata associated with the second file, on the second storage layer on the third memory, wherein the second storage layer is accessible through the temporary directory and second metadata associated with the first storage layer is updated based on storing the second file.

11. The method of claim 10, wherein the first file and the second file share a file name, and the first file from the second memory is provided to the first account and the second file from the third memory is provided to the second account based on the respective first account identifier and the second account identifier upon request.

12. The method of claim 11, wherein the first account lists the temporary directory resulting in a first listing that excludes the second file and the second account lists the temporary directory resulting a second listing that excludes the first file.

13. The method of claim 10, wherein the second account and a third account belong to a group of accounts, which is associated with a group identifier.

14. The method of claim 13, wherein the metadata server directs the third account to store a third file on the second storage layer shared with the second account based on the group identifier.

15. The method of claim 13, wherein the third account accesses the second file.

16. The method of claim 10, wherein a cleanup routine includes at least one of deleting all files in the first storage layer, and reclaiming the first storage layer.

17. The method of claim 16, wherein the cleanup routine is triggered by at least one of the metadata server restarting and the first account logging off.

18. The method of claim 10, wherein the first account identifier is associated with the first metadata and the second account identifier is associated with the second metadata.

19. A computer-readable non-transitory storage medium storing executable instructions of allocating storage, which when executed by a computer system, cause the computer system to:
receive a first request from a first account of a plurality of accounts to create a first file in a temporary directory of a plurality of directories stored in a filesystem, wherein the filesystem is associated with a first memory and is accessible to the plurality of accounts each, of which are associated with a respective account identifier including the first account, which is associated with a first account identifier, and a second account associated with a second account identifier;
request a first storage controller associated with a second memory of a plurality of memories, which are located across a network from the first memory, to create a first storage layer in the second memory, wherein upon being created, the first storage layer is linked to the temporary directory;
assign the first storage layer to the first account;
store the first file on the first storage layer on the second memory, wherein the first storage layer is accessible through the temporary directory and first metadata associated with the first storage layer is updated based on storing the first file;
receive a second request from the second account to create a second file in the temporary directory;
request a second storage controller associated with a third memory of the plurality of memories, the third memory physically separate from the second memory, to create a second storage layer in the third memory, wherein upon being created, the second storage layer is linked to the temporary directory;
assign the second storage layer to the second account; and
store the second file on the second storage layer on the third memory, wherein the second storage layer is accessible through the temporary directory and second metadata associated with the second storage layer is updated based on storing the second file.

20. The computer-readable non-transitory storage medium of claim 19, wherein the first file and the second file share a file name, and the first file from the second memory is provided to the first account and the second file from the third memory is provided to the second account based on the respective first account identifier and the second account identifier upon request.
